(19) United States
(12) Patent Application Publication
(10) Pub. No.: US 2007/0152181 A1
(43) Pub. Date: Jul. 5, 2007

(54) Mesostructured hydrated alumina - surfactant composite compositions and mesostructured transition alumina compositions derived therefrom

(75) Inventors: Thomas J. Pinnavaia, East Lansing, MI (US); Zhaorong Zhang, Okemos, MI (US)

Correspondence Address: Ian C. McLeod;Ian C. McLeod, P.C., 2190 Commons Parkway, Okemos, MI, 48864, US

(73) Assignee: Board of Trustees of Michigan State University, East Lansing, MI (US)

(21) Appl. No.: 11/638,019

(22) Filed: Dec. 13, 2006

Related U.S. Application Data
(63) Continuation-in-part of application No. 11/320,025, filed on Dec. 28, 2005.
Application No. 11/320,025 is a division of application No. 09/917,147, filed on Jul. 27, 2001, now Pat. No. 7,090,824.

(51) Int. Cl. A23J 7/00

(52) U.S. Cl. 252/1; 423/659

(57) ABSTRACT

Mesostructured crystalline alumina compositions with both low angle and wide angle x-ray diffraction patterns and a process for the preparation thereof using a surfactant which is preferably an organic amine compound or a quaternary ammonium compound or a combination of both as a porogen are described. The compositions are useful as catalysts and as absorbents.

### CROSS-REFERENCE TO RELATED APPLICATIONS

This application is a continuation-in-part of Ser. No. 11/320,025 filed Dec. 28, 2005, which is a division of Ser. No. 09/917,147 filed Jul. 27, 2001 (now U.S. Pat. No. 7,090,824), which are incorporated herein by reference in their entireties.

### STATEMENT REGARDING FEDERALLY SPONSORED RESEARCH OR DEVELOPMENT

This invention was funded by NSF grants CHE-9903706 and 0211029. The U.S. Government has certain rights in this invention.

### BACKGROUND OF THE INVENTION

(1) Field of the Invention

The present invention relates to mesostructured forms of hydrated alumina and surfactant composite compositions and the transformation of the composite compositions to mesostructured forms of ETA, KAPPA and CHI transition aluminas and mixtures thereof.

(2) Description of Related Art

The class of aluminum oxide reagents known as “transition aluminas” play commercially important roles as catalysts or catalyst supports in many chemical processes, including the cracking, hydrocracking and hydrodesulfurization of petroleum, the steam reforming of hydrocarbon feed stocks ranging from natural gas to heavy naphtha to produce hydrogen, the synthesis of ammonia, and the control of automobile exhaust emissions, to name a few. Transition aluminas also are used extensively as absorbents.

The usefulness of transition aluminas in catalysis and adsorption processes can be traced to a combination of favorable textural properties (i.e., relatively high surface areas and porosity) and surface chemical properties that can be either acidic or basic depending in part on the transition alumina structure and on the degree of hydration and hydroxylation of the surface. Structurally, all transition aluminas are disordered crystalline phases. Although the oxygen atoms are arranged in regularly ordered close packed arrays, the aluminum atoms adopt different ways of occupying the tetrahedral and octahedral interstacies within the oxygen lattice. Variations in the relative placement of aluminum ions in the tetrahedral and octahedral positions lead to different phases that can be distinguished by NMR techniques and by x-ray diffraction and other scattering methods.

There are several crystalline hydrated alumina and crystalline transition alumina phases, as described by Misra (Industrial Alumina Chemicals, ACS Monograph 184, American Chemical Society, Washington, D.C., (1986)). The crystalline hydrated alumina phases include boehmite and pseudoboehmite, diaspore with the idealized composition AlO(OH), and gibbsite, bayerite, and nordstrandite, each with an idealized composition corresponding to aluminum trihydroxide. When these compositions are written in hydrated form, they conform to aluminum oxide formulas having one and three moles of water, hence the origin of the term “hydrated alumina”. FIG. 1 is a drawing showing the various transitions.

Misra further teaches that upon the dehydration (more precisely, the dehydroxylation) of these hydrated alumina phases at temperatures below about 1100° C., they are transformed to distinguishable transition alumina phases, depending on the structure of the initial hydrated alumina and the dehydration temperature. The various transition alumina phases share the same idealized aluminum oxide formula but differ in the precise arrangement of oxygen lattice and distribution of aluminum atoms in octahedral and tetrahedral interstacies in the oxygen arrays. Gamma-alumina has a face-centered cubic arrangement of oxygen atoms with approximately 75% and 25% aluminum atoms positioned in the octahedral and tetrahedral interstacies, respectively. Eta-alumina although has similar oxygen arrangement to that of gamma form, but in this transition alumina phase only 67% aluminum occupies the octahedral sites with the 33% remaining occupying the tetrahedral sites (Zhou, R. S. and Snyder, R. L. Acta Crystallogr. 47, 617 (1991); Wefers, K. and Misra, C. Oxides and Hydroxides of Aluminum; Alcoa Laboratories (1987)).

In addition to gamma and eta-alumina, other transition forms of alumina include chi, kappa, theta, and delta, among others. These differ from gamma and eta-aluminas in the distribution of aluminum atoms in the interstacies of oxygen lattice and in the stacking pattern of the oxygen atoms, which can be readily characterized by means of X-ray diffraction. (Wefers, K. And Misra, C. Oxides and Hydroxides of Aluminum; Alcoa Laboratories: Paper No. 19 Revised (1987)). The general term “transition alumina” is used to indicate that these phases of alumina are formed in the transition of a hydrated alumina to alpha-alumina, the thermodynamically most stable form of alumina referred to as corundum, wherein the aluminum atoms occupy exclusively octahedral interstacies in the close packed array of oxygen atoms.

Transition aluminas are formed through the thermal dehydration and dehydroxylation of aluminum trihydroxides (e.g., gibbsite or bayerite) or aluminum oxyhydroxides (e.g., boehmite, diaspore). The thermal dehydration of boehmite can afford gamma, eta, delta, or theta forms, depending on the conditions of dehydration and the particle size and degree of crystallinity of the starting boehmite. The thermal dehydration of gibbsite can lead to the formation of chi and kappa, or gamma, delta and theta through formation of boehmite, depending on the heating rate, the dwell temperature and the atmosphere in contact with the solid phase. Also, the thermal dehydration of bayerite can lead to form rho, eta, and theta, depending on the dehydroxylation process. (Wefers, K. and Misra, C., Oxides and Hydroxides of Aluminum, Alcoa Technical Paper No. 19, Revised, Alcoa Laboratories, 1987).

All transition aluminas will form the structurally stable and comparatively inert aluminum oxide known as alpha alumina when heated to a temperature above about 1100° C. Because transition aluminas are formed through thermal dehydration processes, they are sometimes called “activated aluminas”. However, the term “transition aluminas” is more appropriate, because these phases are encountered as intermediates along the thermal pathways that transform hydrated aluminas to alpha alumina.

Transition alumina compositions can be mixtures of transition phases with one transition alumina phase being dominant. But the purity of the transition alumina phase is not the limiting factor in determining the performance properties in catalysis and adsorption. Normally, it is the textural properties (i.e., the pore size, pore volume, and surface area), along with the surface chemical properties, that determine the performance properties of a transition alumina in catalysis and adsorption. As noted above, the phase and hydration state of the surface determines the surface properties. However, the textural properties are determined by the fundamental (primary) particle size of the alumina, as well as the aggregated particle size. By optimizing the textural properties, one may expect to greatly improve the performance properties of a transition alumina derived from a crystalline hydrated alumina. The surface areas of most commercially available gamma aluminas, for example, typically have a BET surface area less than 250 m²/g and a pore volume less than 0.50 cm³/g, which is also associated with broad pore size distributions.

It has been recognized recently that the surface area and porosity of an alumina can be substantially increased through formation of a mesostructure via supramolecular assembly pathways (Bagshaw, S. A.; Pinnavaia, T. J., Angew. Chem. Intern. Ed. Engl. 1996, 35, 1102-1105; Pinnavaia, T. J.; Bagshaw, S. A., U.S. Pat. No. 6,027,706). In this approach a surfactant is used to direct the formation of a mesostructure with walls comprised of the alumina. Removing the surfactant by solvent extraction or by calcination generated a mesostructured alumina. The formation of a mesostructure was indicated by the presence of at least one low angle refection in the x-ray diffraction patterns of the as made alumina—surfactant composition and the final surfactant—free alumina. The low angle diffraction peak corresponded to a pore-to-pore correlation distance of at least 2.0 nm. Several examples of similar mesostructured aluminas have been reported more recently (Davis et al., Chem. Mater. 1996, 8, 1451; Gabelica et al., Microporous Mesoporous Mater. 2000, 35-36, 597; Cabrera et al. Adv. Mater. 1999, 11, 379). For all of these previously reported mesostructured aluminas, however, the walls of the mesostructure were amorphous. That is, neither the oxygen atoms nor the aluminum atoms were arranged on lattice points, as indicated by the absence of Bragg reflections in the wide-angle region of the diffraction patterns. Consequently, these reported mesostructured aluminas could be described as being mesostructured alumina gels. They have limited stability under hydrothermal conditions. Also, these mesostructured aluminas with atomically amorphous framework walls lacked the desired surface acidity and basicity characteristic of an atomically ordered transition alumina, thus limiting their usefulness in chemical catalysis and adsorption.

The transition aluminas derived from aluminum trihydroxides, including eta, chi, kappa, theta, among others are extensively used catalyst components and adsorbents. Consistently, the usefulness of these compositions is also largely determined by their textural properties. Conventional eta-alumina derived from crystalline bayerite can exhibit a surface area up to 400 m²/g associated with slit-shaped pores about 1.0 nm in width. (Wefers, K. and Misra, C., Oxides and Hydroxides of Aluminum, Alcoa Technical Paper No. 19, Revised, Alcoa Laboratories, 1987). The resulting pores are generated by escaping water from the precursor crystal. Formation of such a structure requires very strict control of the calcination process; increasing or decreasing the calcination temperature from the optimum dehydration temperature of 400° C. would drastically deteriorate the surface area. For instance, the surface area of eta-alumina obtained at 500° C. is below 250 m²/g, at least 40% lower than the maximum value. Similar drastic deteriorations in textural properties are also observed for the transition aluminas derived from crystalline gibbsite. For instance, the surface area of the product prepared from gibbsite at 500° C. is about 230 m²/g, 64% of the maximum value observed after calcination at 400° C.

Thus, there is a need to form thermally stable mesostructured forms of transition aluminas with substantially improved textural properties to promote the usefulness of these compositions in materials applications.

### OBJECTS OF THE INVENTION

It is therefore an object of the present invention to provide eta, kappa, and chi transition aluminas and precursor gibbsite and bayerite hydrated aluminas that are mesostructured. It is further an object of the present invention to provide a process for producing such aluminas, which is economical and relatively easy to perform. These and other objects will become increasingly apparent by reference to the following description and the drawings.

### SUMMARY OF THE INVENTION

The present invention relates to a mesostructured crystalline hydrated alumina and surfactant composite composition, the hydrated alumina being selected from the group consisting of bayerite and gibbsite, and mixtures thereof, exhibiting at least one low angle x-ray diffraction line corresponding to a mesostructured hydrated alumina framework with an average repeat distance of at least 2.0 nm and to the average separation between pores in the hydrated alumina framework and wherein the framework pores are occupied by the surfactant. Preferably, wherein the surfactant is selected from the group consisting of an organic amine, an organic quaternary ammonium ion and mixtures thereof. Preferably, wherein the organic amine surfactant is selected from the group comprising an alkylamine and an alkylpolyamine, and mixtures thereof. Most preferably, a mesostructured crystalline transition alumina composition formed through calcinations of a composition at a temperature below 1100° C.

Further, the present invention relates to mesostructured crystalline transition alumina composition, the transition alumina being selected from the group consisting of eta, kappa, chi alumina and mixtures thereof, wherein the composition exhibits at least one low angle Bragg x-ray diffraction line corresponding to an average separation between framework pores of at least 2.0 nm, wherein the surface area is at least 200 m²/g and wherein the pore volume is at least 0.20 cm³/g.

The present invention also relates to a process for the preparation of a mesostructured crystalline hydrated alumina and surfactant composite composition, the crystalline hydrated alumina being selected from the group consisting of bayerite and gibbsite and mixtures thereof, which comprises:

(a) reacting an alumina precursor selected from the group consisting of aluminum salts, oligomeric oxyhydroxyaluminum cations, non-ionic aluminum molecules and mixtures thereof in solution with hydroxide ions;

(b) separating and washing the amorphous hydrated alumina product;

(c) mixing the amorphous hydrated alumina product with a surfactant selected from the group consisting of an organic amine compound, a quaternary amine compound and mixtures thereof;

(d) aging the mixture at a temperature between zero and 200° C. for a period effective in transforming the amorphous hydrated alumina component of the reaction mixture into a crystalline hydrated alumina component selected from the group consisting of bayerite and gibbsite and mixtures thereof; and

(e) separating and drying the resulting mesostructured crystalline hydrated alumina and surfactant composite composition.

The invention also provides a process for the preparation of a mesostructured crystalline hydrated alumina and surfactant composite composition which comprises:

(a) adding water to an aluminum alkoxide solution, optionally in alcohol solution, at a temperature between zero and about 200° C. for a period of time effective for the hydrolysis of the aluminum alkoxide and the formation of an amorphous hydrated alumina precipitate;

(b) filtering and washing the amorphous hydrated alumina product;

(c) mixing the amorphous hydrated alumina product with a surfactant selected from the group consisting of an organic amine compound, an organic quaternary amine compound and mixtures thereof;

(d) aging the mixture at a temperature between zero and 200° C. for a period effective in transforming the amorphous hydrated alumina component of the reaction mixture into a mesostructured crystalline hydrated alumina component selected from the group consisting of bayerite, gibbsite and mixtures thereof; and

(e) separating and drying the resulting mesostructured crystalline hydrated alumina and surfactant composite composition.

The present invention also relates to a process for the formation of a mesostructured transition alumina, the transition alumina being selected from the eta, kappa, and chi alumina and mixtures thereof, wherein the composition exhibits at least one low angle Bragg x-ray diffraction line corresponding to an average separation between framework pores of at least 2.0 nm; wherein the surface area is at least 200 m²/g; and wherein the pore volume is at least 0.20 cm³/g, which comprises treating a mesostructured crystalline hydrated alumina and surfactant composite composition, wherein the surfactant is selected from the group consisting of an organic amine and a quaternary ammonium component, and mixtures thereof and wherein the alumina component of the composite composition is selected from the group consisting of bayerite and gibbsite and mixtures thereof, the composition exhibiting at least one low angle x-ray diffraction line corresponding to a lattice spacing of at least 2.0 nm, to a temperature in the range of 400 to about 900° C. for a period of time effective for the removal of the surfactant component, the dehydration of the hydrated alumina component, and the formation of a mesostructured transition alumina selected from the group consisting of eta, kappa, chi alumina and mixtures thereof.

The present invention also relates to a process for converting a first liquid or gas stream to a second liquid or gas stream using a catalyst, the improvement which comprises:

using as the catalyst or catalyst component an alumina composition selected from the group consisting of

(a) a mesostructured crystalline hydrated alumina composite composition exhibiting at least one low angle x-ray diffraction line corresponding to a mesostructured framework with a repeat distance of at least 2.0 nm between framework pores, and exhibiting multiple wide angle x-ray diffraction lines corresponding to crystalline framework walls selected from the group consisting of bayerite, gibbsite, and mixtures thereof, the crystalline walls being comprised of hydroxide groups with aluminum in interstitial positions and defining regularly spaced framework mesopores, and wherein the mesopores are occupied by a surfactant; and

(b) a mesostructured crystalline transition alumina selected from the group consisting of eta, kappa and chi alumina, wherein the composition exhibits at least one low angle x-ray diffraction line corresponding to an average separation between framework pores of at least 2.0 nm, wherein the surface area is at least 200 m²/g and wherein the pore volume is at least 0.20 cm³/g.

Finally, the present invention relates to a process for adsorbing a component from a gas or liquid stream, the improvement which comprises using as an adsorbent or adsorbent component an alumina composition selected from the group consisting of:

(a) a mesostructured crystalline hydrated alumina and composite composition exhibiting at least one low angle x-ray diffraction line corresponding to a mesostructured framework with a repeat distance of at least 2.0 nm between framework pores, and exhibiting multiple wide angle x-ray diffraction lines corresponding to crystalline framework walls selected from the group consisting of bayerite, gibbsite, and mixtures thereof, the crystalline walls being comprised of hydroxide groups with aluminum in interstitial positions and defining regularly spaced framework mesopores, and wherein the mesopores are occupied by a surfactant; and

(b) a mesostructured crystalline transition alumina selected from the group consisting of eta, kappa and chi alumina, wherein the composition exhibits at least one low angle x-ray diffraction line corresponding to an average separation between framework pores of at least 2.0 nm, wherein the surface area is at least 200 m²/g and wherein the pore volume is at least 0.20 cm³/g. Preferably, wherein the liquid or gas stream is a hydrocarbon. Most preferably, wherein the hydrocarbon is petroleum.

### DESCRIPTION OF THE DRAWINGS

FIG. 1 is a drawing showing the various alumina transitions.

FIGS. 2A and 2B are x-ray diffraction patterns of the mesostructured bayerite—tallow diamine (TDA) composite composition prepared in Example 3.

FIGS. 3A and 3B are x-ray diffraction patterns of the calcined mesostructured eta-alumina prepared through calcination of the mesostructured bayerite—TDA composite composition in Example 3.

FIG. 4A is a graph of nitrogen adsorption-desorption isotherms for the calcined product of Example 3.

FIG. 4B is the calculated pore size distribution for the calcined product of Example 3.

FIG. 5A is a representative small-angle XRD diagram for the mesostructured hydrated alumina—amine composite compositions prepared in Examples 6 to 8; the specific diagram is for the mesostructured bayerite/gibbsite—TDA composite composition taught in Example 7.

FIG. 5B is the wide-angle XRD diagrams of the mesostructured hydrated alumina—amine composite compositions prepared in Examples 6 to 8; (1) mesostructured gibbsite—TDA composite taught in Example 6, (2) mesostructured gibbsite/bayerite—TDA composite taught in Example 7; (3) mesostructured bayerite—TDA composite taught in Example 8.

FIGS. 6A and 6B are XRD diagrams of the mesostructured transition aluminas prepared through calcination of the mesostructured hydrated alumina—TDA composites; (1) mesostructured chi/kappa-alumina prepared from mesostructured gibbsite—TDA composite taught in Example 6, (2) mesostructured eta-alumina prepared from the mesostructured gibbsite/bayerite—TDA composite taught in Example 7, (3) mesostructured eta-alumina prepared from mesostructured bayerite—TDA composite taught in Example 8.

FIGS. 7A and 7B are the XRD diagrams of the mesostructured bayerite—amine composite composition prepared in Example 9.

FIG. 8 is the TEM image of the mesostructured eta-alumina prepared in Example 9.

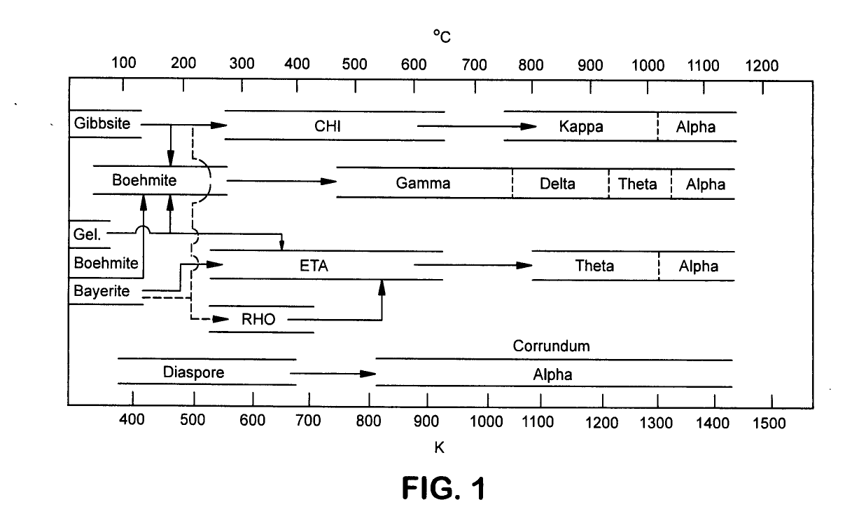

### DEFINITIONS

ALUMINA HYDRATE or HYDRATED ALUMINA means an aluminum hydroxide corresponding to a chemical formula containing three (3) moles of hydroxide per mole of aluminum or an aluminum oxyhydroxide corresponding to a chemical formula containing one (1) oxide and one (1) hydroxide per mole of aluminum. The empirical formulas for hydrated aluminas take the form Al₂O₃.3H₂O in the case of a trihydroxide and Al₂O₃.H₂O in the case of an oxyhydroxide.

TRANSITION ALUMINA means a crystalline aluminum oxide composition formed through the thermal dehydration of a hydrated alumina at a temperature below the temperature needed to form alpha-alumina, the thermodynamically stable form of alumina, which normally forms above 1100° C.

CRYSTALLINE means possessing long-range atomic order effective in providing multiple Bragg reflections in the wide angle X-ray diffraction pattern of the composition, the reflections corresponding to atomic basal spacings less than 1.0 nm.

FRAMEWORK PORES refers to an assembly of intra-particle space within a matrix of crystalline hydrated alumina or crystalline transition alumina, occupied or unoccupied by guest molecules. The assembly of pore space being effective in generating a low angle x-ray diffraction line corresponding to the average separation between the assembled pore spaces, the average separation between such pores being at least 2.0 nm.

MESOSTRUCTURED means possessing a framework pore structure effective in providing at least one Bragg reflection in the low angle region of the X-ray diffraction pattern of the composition corresponding to a basal spacing of at least 2.0 nm.

BASAL SPACING, sometimes also described as LATTICE SPACING, the distance (d) between the structural elements giving rise to the diffraction of X-rays according to the Bragg expression nλ=2dsinθ, where λ is the wavelength of the incident X-radiation, and θ is the scattering angle.

MESOPOROUS means possessing pores, occupied or unoccupied by guest molecules, in the size range 2.0 to 50 nm.

SUPER-MICROPOROUS means possessing pores, occupied or unoccupied by guest molecules in the size range 1.0 to 2.0 nm.

TEXTURAL MESOPORES refer to intra- or inter-particle space, occupied or unoccupied by guest molecules, the space arrangement being ineffective for producing a low angle Bragg X-ray diffraction line.

SURFACTANT refers to an amphiphilic molecule or ion comprising at least one hydrophilic segment and at least one hydrophobic segment, which is capable of forming micelles in polar solutions, especially water, above a critical micelle concentration.

POROGEN is defined as an organic molecule or an ion, with or without surfactant properties, effective in being incorporated within an inorganic host particle and which occupies a space in the said particle, the space corresponding to an intra-particle pore in the super-microporous (1.0-2.0 nm) and mesoporous (2.0-50 nm) size ranges.

FRAMEWORK WALLS refer to the matrix material between framework pores in a mesostructured material.

### DESCRIPTION OF PREFERRED EMBODIMENTS

The present invention describes compositions of matter that comprise mesostructured forms of the hydrated aluminas gibbsite and bayerite and the mesostructured and mesoporous to super-microporous forms of eta, kappa and chi transition aluminas and mixtures thereof formed through calcination of the said mesostructured hydrated aluminas. This invention also discloses mesostructured forms of crystalline hydrated aluminas—surfactant compositions, particularly composite compositions formed with mesostructured gibbsite, bayerite and mixture thereof, which are valuable precursors to several mesostructured and mesoporous to supermicroporous transition aluminas. The textural properties of these mesostructured eta, chi, and kappa transition aluminas are generally superior and more useful in catalytic and adsorption applications in comparison to bulk transition alumina phases that lack a mesostructured framework. The mesostructured forms of transition aluminas are derived in part from the thermal treatment of mesostructured crystalline hydrated aluminas—surfactant composite compositions. Depending on the thermal processing conditions used for the removal of the surfactant porogen and the dehydration of the alumina hydrate phase, mesostructured forms of transition aluminas are formed that are free of the organic porogen and suitable for improved use in adsorption and catalytic applications.

The first embodiment of this invention is directed toward the preparation of mesostructured composite compositions with crystalline gibbsite and bayerite hydrated aluminas in the framework walls and surfactant in the framework pores. In the parent application Ser. No. 09/917,147, we have specifically described the preparation of a mesostructured composite composition comprised of crystalline boehmite in the framework walls and nonionic surfactant in the pores, denoted MSU-S/B. In the present invention, we further disclose the preparation of mesostructured composite compositions of hydrated aluminas including bayerite, gibbsite, and mixture thereof. Evidence for the formation of mesostructured bayerite and gibbsite phases are provided by the presence of at least one x-ray diffraction line in the small-angle region corresponding to a lattice spacing of at least 2.0 nm. This spacing also corresponds to the average separation between the intra-particle framework pores occupied by the surfactant. In addition, the diffraction patterns of the mesostructured compositions exhibit wide-angle reflections characteristic of a bulk, atomically ordered gibbsite, and bayerite phases and mixtures thereof. This combination of small-angle and wide-angle x-ray reflections is unique among bayerite and gibbsite phases. The small angle reflection is indicative of a network that is ordered on a mesoscopic length scale (i.e., 2.0-50 nm), whereas the wide-angle reflections show that the particles comprising the mesoscopic network contain atomically ordered hydrated alumina phases.

The mesostructured composite compositions comprised of crystalline bayerite, gibbsite and mixed bayerite/gibbsite framework walls of this invention are prepared through direct assembly of colloidal amorphous hydrated alumina formed through the controlled hydrolysis of aluminum salts, oligomeric oxyhydroxyaluminum cations, and non-ionic aluminum molecules in the presence of a nonionic or ionic surfactant as the structure directing porogen. The presence of the surfactant controls the growth of the mesostructured composite composition. The mesostructured forms of hydrated alumina—surfactant composite compositions derived from the colloidal precursors generally exhibit nanocrystalline morphology.

Another method for the selective formation of the mesostructured hydrated alumina—surfactant composite composition utilizes the hydrolysis of an aluminum alkoxide in the presence of a surfactant as a means of forming a mesostructured network of intra-particle framework pores that give rise to a small-angle Bragg x-ray diffraction line corresponding to a lattice spacing between the framework pores of at least 2.0 nm. Aluminum alkoxides have been used extensively to form non-mesostructured broad pores of boehmite and pseudoboehmite compositions with no low angle x-ray diffraction (Industrial Alumina Chemicals, C. Misra, ACS Monograph 184 ACS, Washington, D.C. p. 48 (1986)) for the preparation of the boehmite—surfactant composite compositions. However, the possibility of forming mesostructured bayerite and gibbsite composite compositions through an aluminum alkoxide pathway has gone unrecognized up to date. The present invention demonstrates the utility of aluminum alkoxide for the preparation of hydrated alumina—surfactant composites. Moreover, noting the high cost of aluminum alkoxides and the use low cost aluminum salts as the aluminum precursor are also disclosed.

The second principal embodiment of this invention is directed at mesostructured forms of eta, kappa and chi transition aluminas and mixtures thereof. The structural properties of these transition alumina compositions parallel those described above for mesostructured forms of hydrated aluminas, except that the aluminum oxide comprising the mesostructured network is an atomically ordered aluminum oxide selected from the group consisting of eta, chi, and kappa transition aluminas. Thus, the mesostructured transition aluminas of this invention exhibit a low angle x-ray diffraction peak corresponding to an average spacing of at least 2.0 nm between intra-particle framework pores, as well as and wide angle diffraction peaks characteristic of the said atomically ordered transition aluminas. These mesostructured transition aluminas have substantially improved structural stability and surface areas. For instance, the mesostructured eta-alumina exhibits a surface area above 350 m²/g after having been calcined at 500° C., a value 40% larger than the maximum value (250 m²/g) observed for a conventional eta-alumina obtained under analogous calcination conditions (Industrial Alumina Chemicals, C. Misra, ACS Monograph 184 ACS, Washington, D.C. p. 48 (1986). The large surface areas of the mesostructured transition aluminas of this invention are particularly attractive as catalysts and catalyst supports.

The mesostructured transition aluminas of this invention are formed from the thermal dehydration of mesostructured composite composition of hydrated aluminas consisting of bayerite, gibbsite, and mixtures thereof that have been prepared in the presence of a surfactant as a structure-directing porogen. In the preferred forms of the invention, the mesostructured hydrated alumina compositions are prepared from the controlled hydrolysis of aluminum precursors in the presence of the surfactant. The crystalline phases of the hydrated alumina contained in the mesostructured composite are essentially determined by the reaction conditions, particularly the reactant stoichiometry, reaction temperature, and reaction time. It is particularly preferred that an amine surfactant be used in the formation of the hydrated alumina composites in part, because they contribute to the hydrolysis process and improve the pore distribution of the final mesostructured transition alumina products. The resulting mesostructured hydrated alumina composite composition is then heated to a temperature above about 400° C. to remove the organic surfactant and to transform the hydrated alumina component to a mesostructured and mesoporous transition alumina.

The disclosed approaches to mesostructured transition aluminas may not be restricted to the use of gibbsite, bayerite and mixtures thereof as the hydrated alumina component in the initial hydrated alumina-surfactant composition. Other forms of hydrated aluminas include diaspore and nordstrandite. Although these hydrated forms of alumina are generally more difficult to prepare than gibbsite, bayerite or boehmite, they can be thermally dehydrated to transition aluminas. Thus, possible alternatives to the hydrated aluminas disclosed in this art include diaspore and nordstrandite. Also, it is known from the teachings of Misra that one transition alumina phase can be transformed into another transition alumina under suitable processing conditions. The teachings of the present invention applies as well to the preparation of other mesostructured transition alumina phases, including delta, theta, rho, as well as gamma alumina.

The mesostructured hydrated alumina composite composition of this invention can be formed from colloidal amorphous hydrated alumina derived from a variety of precursors. Suitable precursors include the following general groups of aluminum compounds:
ionic aluminum salts containing hydrated aluminum cations, such as aluminum trichloride hexahydrate, aluminum trinitrate nonahydrate, and the hydrolyzed aluminum cations of these salts when they are dissolved in aqueous solution (for Example, hydrated Al(OH) (H₂O)₅²⁺ and Al₂(OH)₂(H₂O)₈⁴⁺ cations);
non-ionic aluminum-containing molecular composition, such as an aluminum alkoxides, anhydrous aluminum halides, aluminum beta-diketonates and the like;
Oligomeric aluminum cations, such as the cation comprising aluminum chlorhydrate, Al₁₃O₄ (OH)₂₄(H₂O)₁₂⁷⁺, the related Al₃₀ cationic oligomer, and like ions of higher aluminum nuclearity (J. Rowsell, and L. F. Nazar, J. Am. Chem. Soc., 2000 (122) 3777. L. Allouche, G. Gerardin, T. Loiseau, G. Ferey, and F. Taulelle, Angew. Chem. Int. Ed. 2000, 39 (3) 511); and
Oligomeric oxyhydroxycations of aluminum formed by reaction of mixtures of aluminum cations in solution and finely divided aluminum metal.

The porogens used in forming the mesostructured alumina compositions of this invention include nonionic, organic anion compounds preferably selected from the group comprising alkylamine, alkylpolyamine, or quaternary ammonium, ionic quaternary ammonium compounds comprising alkylene moieties containing at least 10 carbon atoms, particularly those ammonium cations that exhibit surfactant properties.

The potential applications of mesostructured and mesoporous transition catalyst are many, but most of the applications fall into two categories as follows:

A. Catalyst Support and Adsorbent:

The advantage mesostructured and mesoporous transition aluminas have over conventional transition aluminas is the high surface area and more uniform pore distribution provided by these materials. The higher surface area provided by a mesostructured transition alumina allows increased loading of a catalyst on the support. It also improves the dispersion and accessibility of the active catalyst on the support surface. Also, the more uniform pore size distribution of a mesostructured transition alumina limits the aggregation and growth of supported metal catalysts within the framework pores and allows more of the surface metal atoms of the supported catalyst to be accessible for reaction. Clearly, the larger the surface area and the larger, more uniform size distribution of the framework pores of a mesostructured alumina are distinct advantages of a mesostructured alumina for adsorption and chromatographic molecular separations. Also, larger mesopores mean that a mesostructured alumina can absorb larger molecules, such as polymers and biological molecules, in comparison to conventional transition aluminas.

B. Catalyst Component and Binder

Transition aluminas also are used extensively as an active catalyst component and as a binder in multi-component heterogeneous catalysts. One very important use of transition aluminas is as a component of heterogeneous catalysts for petroleum refining. For instance, the catalyst particles used in the fluidized catalytic cracking of gas oil for the production of transportation fuels are formed by spray drying aqueous suspensions of transition alumina admixed with zeolites and other active oxides. To function properly, the particles must have the appropriate size, hardness and bulk density. The high framework pore volume and the ability to control the framework pore volume of a mesostructured transition aluminas of this invention allows one to mediate the bulk density of such composite FCC particles for use in fluidized bed applications. Thus, the mesostructured and mesoporous transition aluminas of the present invention provide many benefits over conventional transition aluminas in the design of catalyst supports, adsorbents, and multi-component heterogeneous catalyst particles.

### EXAMPLES

In the Examples provided below, we describe the synthesis and structural properties of the mesostructured forms of hydrated alumina—surfactant composite compositions and transition alumina phases derived from the said hydrated alumina composites. The compositions were characterized by X-ray diffraction (XRD) using a Rigaku Rotaflex equipped with CuK-alpha radiation (wavelength=0.1541 nm). The presence of small-angle Bragg diffraction peaks corresponding to average pore to pore correlation distances (i.e., average pore separations) of at least 2.0 nm was indicative of a mesostructured material. Wide-angle XRD reflections were used to indicate the presence of atomically ordered walls for the hydrated alumina—surfactant composite compositions and the mesostructured transition aluminas derived from the said composite compositions.

Nitrogen BET surface areas, pore volumes and framework pore sizes were determined using nitrogen adsorption-desorption methods. The sorptometer used to record the adsorption—desorption isotherms was an ASAP 2010 or a Tristar instrument manufactured by Micromeritics Corporation. The samples for adsorption measurement were degassed at 150° C. and <10-5 torr for 12 h before measurement. In defining the pore size distribution, the BJH model was applied to both the adsorption and desorption isotherms in order to characterized the framework pore structure.

Particle morphology was examined by means of Transmission Electron Microscopy (TEM) using a JEOL 100 CX2 electron microscope operated at 120 kV. The sample grid was prepared by sonicating the powdered sample in ethanol and drying one drop of the suspension over a reinforced carbon-coated copper grid.

### Examples 1 to 5

These Examples illustrate the preparation of mesostructured and super-microporous to mesoporous eta transition alumina from a mesostructured bayerite hydrated alumina—amine surfactant composite. The mesostructured composite composition was formed through the reaction of a precipitated amorphous aluminum hydroxide with a non-ionic amine surfactant as the structure directing porogen. The amorphous aluminum hydroxide was prepared by the hydrolysis of an aluminum source selected from the group consisting of an aluminum alkoxide, an aluminum salt or an oligomeric aluminum cation. An aqueous solution of a mineral base, most preferably ammonium hydroxide, was used for the hydrolysis of an aluminum salt or an aluminum oligocation. The amorphous aluminum hydroxide also was obtained through the reaction of aluminate anions with a mineral acid (hydrochloric acid). The amine surfactants were long carbon chain amines (C₁₀ to C₂₂) particularly, dodecylamine (DDA, C₁₂H₂₅NH₂, Aldrich), hexadecylamine (HAD, C₁₆H₃₃NH₂, Aldrich), a tallow diamine [TDA, C₁₆H₃₃NH(CH(CH₃)CH₂NH₂, Tomah³], a tallow triamine [TTrA, C₁₆H₃₃NH(CH(CH₃)CH₂NH)₂H, Tomah³], and a tallow tetraamine [TTeA, C₁₆H₃₃NH(CH(CH₃)NH)₃H, Tomah³].

In a typical synthesis, 37.5 g (0.1 mol) of aluminum nitrate nonahydrate (Aldrich, 98%) was dissolved into 200 ml de-ionized water. To this solution was added 27.3 g (0.45 mol) of concentrated ammonium hydroxide under vigorous-stirring. After allowing for the reaction mixture to age under gentle stirring for 1 h, the resulting precipitate was centrifuged and washed with de-ionized water to remove the ammonium nitrate by-product. Part of the resulting precipitate was air-dried and calcined at 500° C. to determine the aluminum hydroxide content of the mixture. An amount of the aluminum hydroxide precipitate containing 1.56 g of aluminum hydroxide (20 mmol) then was mixed with 1.2 g (4 mmol) of TDA in a blender. The resulting milky fluid was allowed to age at 55° C. in a shaker bath for 24 h to form a homogeneous colloidal mixture. This mixture was hydrothermally treated in an autoclave at 100° C. for 24 h to obtain a mesostructured composite comprised of crystalline bayerite hydrated alumina framework walls and amine surfactant filling the intra-particle framework pores. This nanocomposite was separated by centrifugation, dried in air overnight and at 100° C. for 6 h, then calcined at 225° C. for 3 h and at 500° C. for 4 h, using a ramp speed of 2° C./min, to obtain a surfactant-free mesostructured eta-alumina.

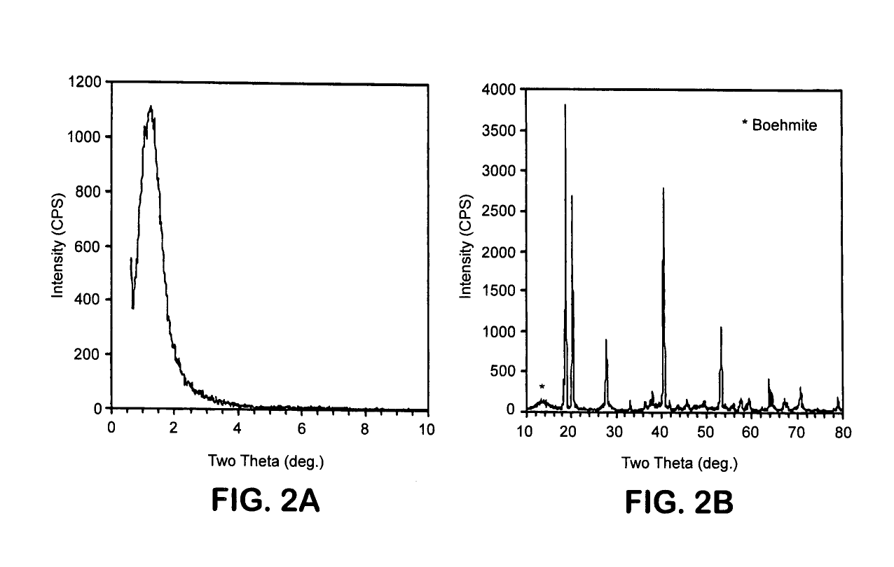

FIGS. 2A and 2B show the powder X-ray diffraction (XRD) pattern for the mesostructured hydrated alumina—TDA surfactant composite. The single Bragg reflection in the small angle region of the XRD pattern (0.5-10 degrees two-theta), FIG. 2A, is attributed to the average distance between the TDA-filled intracrystal mesopores of the mesostructured composite composition. The wide-angle X-ray pattern (>10 degrees two-theta) (FIG. 2B) of the composite compositions clearly shows the characteristic Bragg reflections of the hydrated alumina bayerite (JCPDS Card # 20-0011).

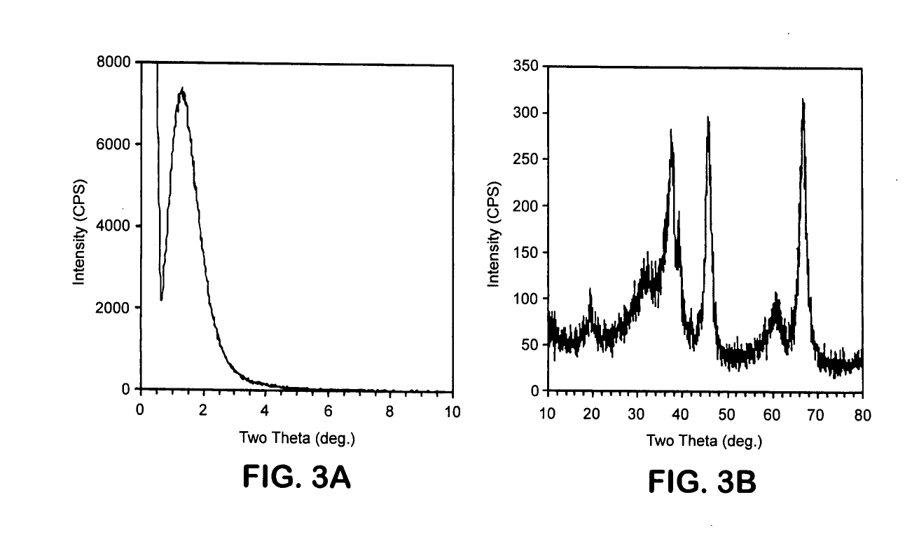

FIG. 3 provides the XRD diagrams for the eta phase transition alumina product formed by calcination of the mesostructured hydrated alumina—surfactant composite composition characterized by the XRD patterns shown in FIGS. 2A and 2B. The small-angle segment of the pattern (FIG. 3A), shows a single reflection which corresponds to the average distance between the intra-particle framework mesopores. In the wide-angle XRD pattern of this product (FIG. 3B), the XRD reflections characteristic of the eta—form of a transition alumina (JCPDS Card # 4-0875) were clearly observed.

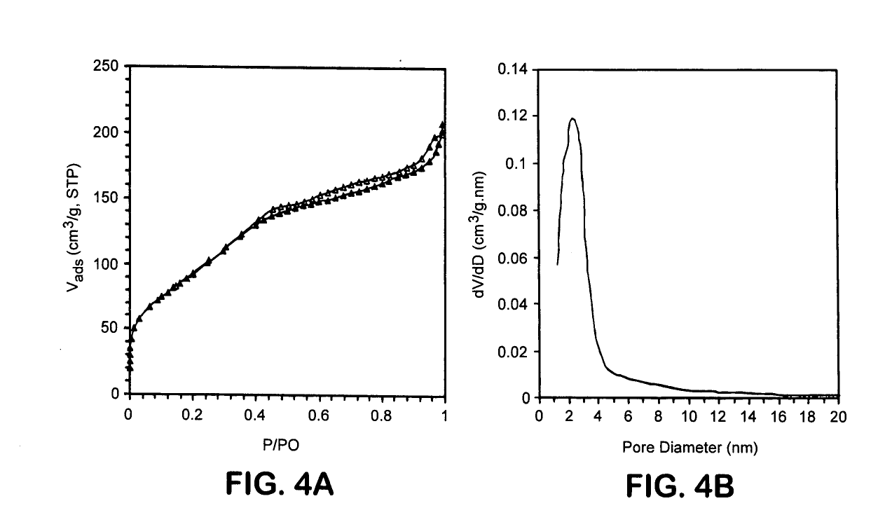

FIGS. 4A and 4B provide the nitrogen adsorption-desorption isotherms and the corresponding Barrett-Joyner-Halenda (BJH) pore size distributions for the calcined mesostructured eta-phase transition alumina characterized by the XRD patterns of FIGS. 3A and 3B. The up-take of nitrogen (FIG. 4A) in relative pressure (P/Po) range 0.1-0.4 indicated the presence of well-defined mesoporosity with pore diameters close to 2 nm. Consistent with the nitrogen adsorption isotherm, a narrow BJH pore distribution centered near 2.1 nm is obtained from the adsorption isotherm. (FIG. 4B). It is noteworthy that the pore size distribution extends to the size domain below 2.0 nm, demonstrating the product is supermicroporous to mesoporous. Similar super microporous to mesoporous behavior is observed for all of the mesostructured transition aluminas of this invention.

Mesostructured and mesoporous eta-aluminas with qualitatively similar structure also were prepared using other non-ionic amine surfactants as structure directing porogens for the assembly of mesostructured bayerite hydrated alumina—surfactant composite precursors. The structural properties of the obtained mesostructured and mesoporous eta-phase transition alumina products are summarized as follows:

### Example 1

Surfactant: Dodecylamine, DDA
Surfactant/Al₂O₃ ratio: 0.40 mol/mol
Small angle XRD basal spacing: 5.5 nm
Average BJH pore size: 2.0 nm
BET surface area: 357 m²/g
Framework Pore volume: 0.34 cm³/g

### Example 2

Surfactant: Hexadecylamine, HDA
Surfactant/Al₂O₃ ratio: 0.40 mol/mol
Small angle XRD basal spacing: 6.5 nm
Average BJH pore size: 2.2 nm
BET surface area: 356 m²/g
Pore volume: 0.39 cm³/g

### Example 3

Surfactant: Tallow diamine, TDA
Surfactant/Al₂O₃ ratio: 0.20 mol/mol
Small angle XRD basal spacing: 6.5 nm
Average BJH pore size: 2.2 nm
BET surface area: 366 m²/g
Pore volume: 0.33 cm³/g

### Example 4

Surfactant: Tallow triamine, TTrA
Surfactant/Al₂O₃ ratio: 0.15 mol/mol
Small angle basal spacing: 6.8 nm
Average BJH pore size: 2.2 nm
BET surface area: 366 m²/g
Pore volume: 0.34 m²/g

### Example 5

Surfactant: Tallow tetraamine, TTeA
Surfactant/Al₂O₃ ratio: 0.1 mol/mol
Small angle basal spacing: 7.2 nm
Average BJH pore size: 2.2 nm
BET surface area: 374 m²/g—
Pore volume: 0.33 cm³/g

### Examples 6 to 8

In these Examples, the preparation of the mesostructured and mesoporous eta is demonstrated and kappa, and chi transition aluminas from a mesostructured non-ionic amine surfactant and a hydrated alumina nanocomposite with crystalline bayerite, bayerite/gibbsite mixture, and bayerite framework walls and the amine surfactant as the structure directing porogen filling the pores between the framework walls.

In a typical synthesis, 37.5 g (0.1 mol) of aluminum nitrate nonahydrate was hydrolyzed, under vigorous stirring, through the addition of the following amounts of concentrated ammonium hydroxide (28 wt. % NH₃):

### Example 6

### 18.21 g (0.30 mol NH₄OH,)

### Example 7

### 21.86 g (0.36 mol NH₄OH)

### Example 8

### 27.3 g (0.45 mol NH₄OH)

A portion of each precipitate containing 1.56 g (20 mmol) of aluminum hydroxide was dispersed in 45 ml of de-ionized water and to the resulting mixture was added under vigorous stirring 1.25 g (4.2 mmol) of TDA surfactant dissolved in 5 ml ethanol. The resultant colloidal mixture was then processed as described by the protocol of Examples 1 to 5 to form mesostructured crystalline bayerite/gibbsite hydrated alumina—surfactant composite compositions. Calcination of the composite compositions at 500° C. afforded a mesostructured and mesoporous transition alumina product.

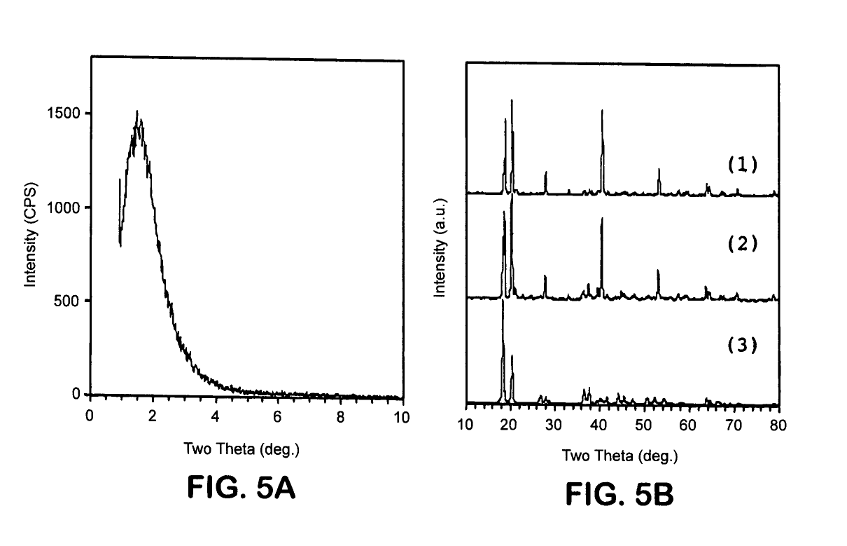

FIG. 5A shows a representative small angle XRD pattern for the mesostructured hydrated alumina—TDA composite synthesized in Example 7. The presence of a small angle Bragg reflection line verifies the presence of a mesostructure. The wide angle XRD pattern [10-80 degrees (two-theta)] for the composite composition of Example 6 shown in FIG. 5B, Trace (1), is characteristic of gibbsite (JCPDS Card # 33-0018). The mesostructured composite product of Example 7 shows a wide angle XRD pattern indicative of the presence of a mixture of mesostructured gibbsite and bayerite. The composite composition of Example 8 exhibit a wide angle XRD pattern (Trace (3)) is characteristic of a mesostructured bayerite hydrated alumina—surfactant composite (JCPDS Card # 20-0011).

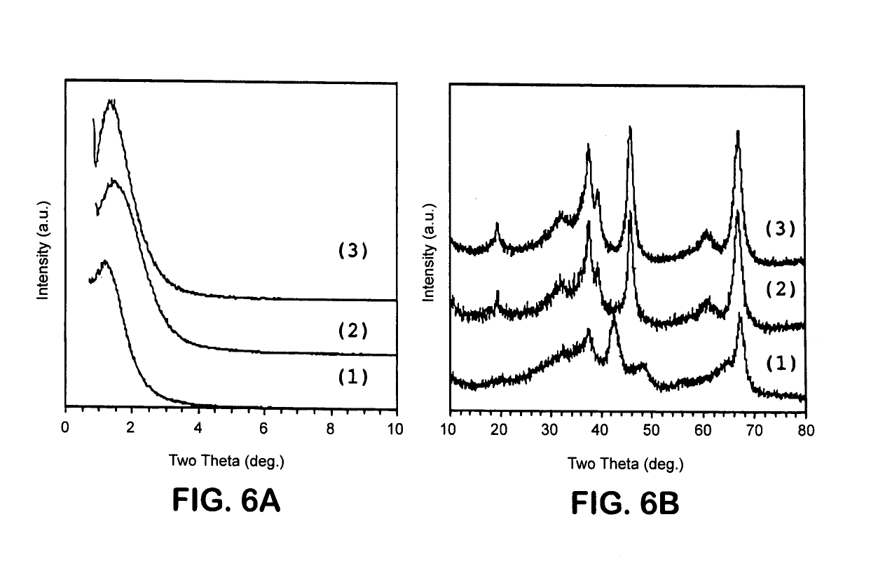

Depicted in FIGS. 6A and 6B are the XRD diagrams of the mesostructured transition aluminas prepared through the calcination at 500° C. of each of the hydrated alumina, TDA surfactant composite compositions of Examples 6, 7, and 8. All these calcined products exhibit a small angle Bragg XRD reflection indicative of a mesostructured framework. The small-angle XRD patterns shown in FIG. 6A, verify the formation of a mesostructured transition alumina for each of the calcined products of Examples 6, 7, and 8. The wide-angle diagrams depicted in FIG. 6B show the framework walls of the calcined mesostructure of Example 6 (Trace (1)) to be made of transition alumina chi and kappa (JCPDS Cards # 04-0880 and # 04-0788). In sharp contrast, the mesostructures obtained through calcination of the mesostructured bayerite/gibbsite-TDA composite compositions of Examples 7 and 8 (Traces (2) and (3), respectively) exhibit wide angle Bragg reflections characteristic of phase-pure eta-alumina (JCPDS Card # 4-0875). The properties of these mesostructured transition aluminas are summarized as follows:

### Example 6

Mesostructured transition alumina: Chi and Kappa
Small angle basal spacing: 10.7 nm
BJH pore diameter: 2.2 nm
BET surface area 325 m²/g
Framework pore volume: 0.43 cm³/g

### Example 7

Mesostructured transition alumina: eta-alumina
Small angle basal spacing: 5.6 nm
BJH pore diameter: 2.1 nm
BET surface area: 430 m²/g
Framework pore volume: 0.34 cm³/g

### Example 8

Mesostructured transition alumina: eta-alumina
Small angle basal spacing: 6.0 nm
BJH pore diameter: 2.2 nm
BET surface area 336 m²/g
Framework pore volume: 0.36 cm³/g

### Example 9

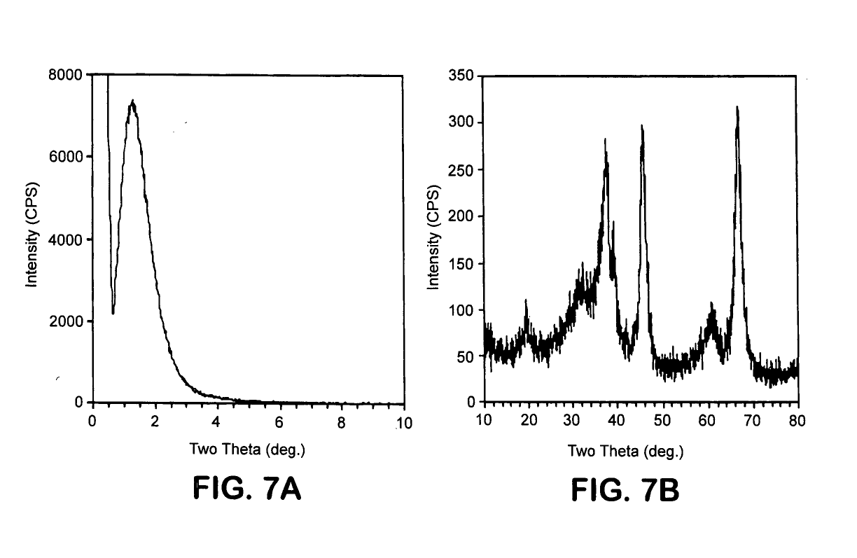

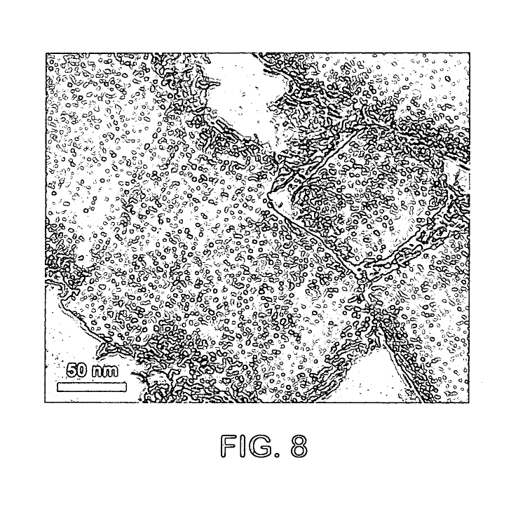

In this Example, the direct synthesis of a mesostructured bayerite hydrated alumina—amine composite is demonstrated through the reaction of an aluminum alkoxide with an amine surfactant followed by hydrolysis in water and the thermal transformation of the resultant mesostructured composite composition to mesostructured eta-alumina. In a typical synthesis, 4.92 g of Al(OsBu)₃ (0.02 mol) was dissolved in 5 ml sec-butanol. To this solution was added 1.25 g of TDA (4.2 mmol). After allowing the mixture to react at 90° C. for 12 h, the resulting solution was dropped into 45 ml deionized water under vigorous stirring. The colloidal suspension was then aged at 45° C. for 24 h, followed by aging at 100° C. for an additional 24 h. The precipitate was filtered, rinsed with ethanol, and air-dried to obtain a mesostructured bayerite-TDA composite composition. This composition was then transformed to mesostructured eta-alumina through calcination at 500° C. for 3 h, using a ramp rate of 2° C./min. FIGS. 7A and 7B show the XRD diagrams of the calcined product. In the small-angle pattern (FIG. 7A), a Bragg reflection indicative of a mesostructured product was observed. In the wide-angle pattern (FIG. 7B), reflections typical of eta-alumina were clearly expressed. Depicted in FIG. 8 is a transmission electron microscopy image of the calcined mesostructured eta-alumina. A well-expressed mesostructure with uniformly separated framework pores was observed. The properties of the mesostructured eta-alumina are summarized as follows:
Small angle basal spacing: 5.4 nm
BJH pore diameter: 2.0 nm
BET surface area 339 m²/g
Pore volume: 0.32 cm³/g

In the present invention, the surfactant is removed during calcinations of the hydrated alumina. This presents collapse of the mesostructured alumina. Preferably, the calcinations is done slowly (0.5 to 2.0° C.) per minute. From 100° C. to the final calcinations temperature, usually above about 300° C.

It is intended that the foregoing description be only illustrative of the present invention and that the present invention be limited only by the hereinafter appended claims.

We claim:

1. A mesostructured crystalline hydrated alumina and surfactant composite composition, the hydrated alumina being selected from the group consisting of bayerite and gibbsite, and mixtures thereof, exhibiting at least one low angle x-ray diffraction line corresponding to a mesostructured hydrated alumina framework with an average repeat distance of at least 2.0 nm and to the average separation between pores in the hydrated alumina framework and wherein the framework pores are occupied by the surfactant.

2. The composite composition of claim 1 wherein the surfactant is selected from the group consisting of an organic amine, an organic quaternary ammonium ion and mixtures thereof.

3. The composite composition of claim 2 wherein the organic amine surfactant is selected from the group comprising an alkylamine and a alkylpolyamine and mixtures thereof.

4. A mesostructured crystalline transition alumina composition formed through calcination of a composition of claim 1 at a temperature below 1100° C.

5. A mesostructured crystalline transition alumina composition, the transition alumina being selected from the group consisting of eta, kappa, chi, alumina and mixtures thereof, wherein the composition exhibits at least one low angle Bragg x-ray diffraction line corresponding to an average separation between framework pores of at least 2.0 nm, wherein the surface area is at least 200 m²/g and wherein the pore volume is at least 0.20 cm³/g.

6. A process for the preparation of a mesostructured crystalline hydrated alumina and surfactant composite composition, the crystalline hydrated alumina being selected from the group consisting of bayerite and gibbsite and mixtures thereof, which comprises:
(a) reacting an alumina precursor selected from the group consisting of aluminum salts, oligomeric oxyhydroxyaluminum cations, non-ionic aluminum molecules and mixtures thereof in solution with hydroxide ions;
(b) separating and washing the amorphous hydrated alumina product;
(c) mixing the amorphous hydrated alumina product with a surfactant selected from the group consisting of an organic amine compound, a quaternary amine compound and mixtures thereof;
(d) aging the mixture at a temperature between zero and 200° C. for a period effective in transforming the amorphous hydrated alumina component of the reaction mixture into a crystalline hydrated alumina component selected from the group consisting of bayerite and gibbsite and mixtures thereof; and
(e) separating and drying the resulting mesostructured crystalline hydrated alumina and surfactant composite composition.

7. A process for the preparation of a mesostructured crystalline hydrated alumina and surfactant composite composition which comprises:
(a) adding water to an aluminum alkoxide solution, optionally in alcohol solution, at a temperature between zero and about 200° C. for a period of time effective for the hydrolysis of the aluminum alkoxide and the formation of an amorphous hydrated alumina precipitate;
(b) filtering and washing the amorphous hydrated alumina product;
(c) mixing the amorphous hydrated alumina product with a surfactant selected from the group consisting of an organic amine compound, and organic quaternary amine compound and mixtures thereof;
(d) aging the mixture at a temperature between zero and 200° C. for a period effective in transforming the amorphous hydrated alumina component of the reaction mixture into a mesostructured crystalline hydrated alumina component selected from the group consisting of bayerite, gibbsite and mixtures thereof; and
(e) separating and drying the resulting mesostructured crystalline hydrated alumina—surfactant composite composition.

8. A process for the formation of a mesostructured transition alumina, the transition alumina being selected from the group eta, kappa, and chi alumina and mixtures thereof, wherein the composition exhibits at least one low angle Bragg x-ray diffraction line corresponding to an average separation between framework pores of at least 2.0 nm; wherein the surface area is at least 200 m²/g; and wherein the pore volume is at least 0.20 cm³/g, which comprises treating a mesostructured crystalline hydrated alumina and surfactant composite composition, wherein the surfactant is selected from the group consisting of an organic amine and a quaternary ammonium component, and mixtures thereof, and wherein the alumina component of the composite composition is selected from the group consisting of bayerite and gibbsite and mixtures thereof, the composition exhibiting at least one low angle x-ray diffraction line corresponding to a lattice spacing of at least 2.0 nm, to a temperature in the range of 400 to about 900° C. for a period of time effective for the removal of the surfactant component, the dehydration of the hydrated alumina component, and the formation of a mesostructured transition alumina selected from the group consisting of eta, kappa, chi alumina and mixtures thereof.

9. In a process for converting a first liquid or gas stream to a second liquid or gas stream using a catalyst, the improvement which comprises:
using as the catalyst or catalyst component an alumina composition selected from the group consisting of:
(a) a mesostructured crystalline hydrated alumina composite composition exhibiting at least one low angle x-ray diffraction line corresponding to a mesostructured framework with a repeat distance of at least 2.0 nm between framework pores, and exhibiting multiple wide angle x-ray diffraction lines corresponding to crystalline framework walls selected from the group consisting of bayerite, gibbsite, and mixtures thereof, the crystalline walls being comprised of hydroxide groups with aluminum in interstitial positions and defining regularly spaced framework mesopores, and wherein the mesopores are occupied by a surfactant; and
(b) a mesostructured crystalline transition alumina selected from the group consisting of eta, kappa and chi alumina, wherein the composition exhibits at least one low angle x-ray diffraction line corresponding to an average separation between framework pores of at least 2.0 nm, wherein the surface area is at least 200 m²/g and wherein the pore volume is at least 0.20 cm³/g.

10. In a process for adsorbing a component from a gas or liquid stream, the improvement which comprises using as an adsorbent or adsorbent component an alumina composition selected from the group consisting of:
(a) a mesostructured crystalline hydrated alumina and composite composition exhibiting at least one low angle x-ray diffraction line corresponding to a mesostructured framework with a repeat distance of at least 2.0 nm between framework pores, and exhibiting multiple wide angle x-ray diffraction lines corresponding to crystalline framework walls selected from the group consisting of bayerite, gibbsite, and mixtures thereof, the crystalline walls being comprised of hydroxide groups with aluminum in interstitial positions and defining regularly spaced framework mesopores, and wherein the mesopores are occupied by a surfactant; and
(b) a mesostructured crystalline transition alumina selected from the group consisting of eta, kappa and chi alumina, wherein the composition exhibits at least one low angle x-ray diffraction line corresponding to an average separation between framework pores of at least 2.0 nm, wherein the surface area is at least 200 m²/g and wherein the pore volume is at least 0.20 cm³/g.

11. The process of claim 9 wherein the liquid or gas stream is a hydrocarbon.

12. The process of claim 11 wherein the hydrocarbon is petroleum.
